(19) United States
(12) Patent Application Publication
(10) Pub. No.: US 2024/0051090 A1
(43) Pub. Date: Feb. 15, 2024

(54) Repeatable Clamping Device

(71) Applicant: Michael Brian Sargent, Windsor, CO (US)

(72) Inventor: Michael Brian Sargent, Windsor, CO (US)

(21) Appl. No.: 18/233,326

(22) Filed: Aug. 13, 2023

Related U.S. Application Data
(60) Provisional application No. 63/397,991, filed on Aug. 15, 2022.

(51) Int. Cl. B25B 5/10; B23Q 3/06

(52) U.S. Cl. CPC B25B 5/103; B23Q 3/06; B25B 5/102

(57) ABSTRACT

A clamping device is described which enables repeatable positioning of top-tooling relative to a base in all six degrees of freedom. The device utilizes a swiveling pullstud and ramp interaction to achieve preloading in the z-direction while minimizing undesirable lateral loads. The device ensures consistent top-tooling relocation for precision positioning applications such as machining and inspection.

### CROSS-REFERENCE TO RELATED APPLICATION

This application claims the benefit of U.S. Provisional Patent Application No. 63/397,991 filed Aug. 15, 2022.

### BACKGROUND

In the manufacturing industry, it is common to fix components in place for machining, inspection, and other manufacturing operations. It is a common requirement in practice to clamp a workpiece holder with repetitive accuracy, such that all 6 degrees of freedom are constrained, according to the three linear coordinates X, Y, Z and three rotary directions (rotary about the X axis or “A”, rotary about the Y axis or “B”, and rotary about the Z axis or “C”.

A common tooling fixture used to fix parts in place is commonly called a “zero point system” or “pallet changer”, which performs the function of fixing the top-tooling in place. The top-tooling can take many forms. For example, it can be a generic block of metal, sometimes called a “pallet”, which will be machined into a desired shape by the user to create a custom fixture for holding parts while they are machined. The top-tooling could also be a vise, for example, or a vacuum chuck. It could also be other devices that might not be considered workholding devices, such as a robotic arm, tool measuring probe, or work stop.

There are various existing devices for accomplishing the fixing of top-tooling to the base. However, they have varying degrees of repeatability and high cost.

A problem with existing solutions is that to achieve higher repeatability of the pallet changer, the various mating components usually must also be manufactured with a high degree of precision, which results in considerable expense to be incurred.

When the positioning of the top-tooling relative to the base is not sufficiently repeatable, extra efforts are generally taken by the user to compensate for the changed position. The user might compensate by probing one or more points on the top-tooling to determine its new position, and then use additional work offsets to communicate to the equipment how the position has changed.

Another problem with currently available solutions is that the act of installing and uninstalling the top-tooling is prone to failure. Many existing systems utilize a pinned connection between the top-tooling and the base in order to locate the top-tooling. Commonly, two or more pins and corresponding holes are used. The pins and holes are commonly cylindrical, but they can be in other shapes. The problem with such a connection is that clearance is required between the pins and the corresponding holes so that they may slip by one another during installation and removal. This clearance leads to uncertainty about the relative position of the components. In an attempt to obtain increasing levels of repeatability, the clearance is often designed to be very small.

In addition to the problem of positional uncertainty, a common pinned connection is prone to jamming, in which the top-tooling becomes stuck before fully seating against the main body of the base. Jamming can be caused by foreign material coming between the pin and its mating hole. It can also be caused by misalignment of the pins/holes due to manufacturing errors. It can also be caused by misalignment of the two components by the user. If the pins are not sufficiently aligned with the holes due to one or both being tilted, they may not self-align and may instead lock in place before the components are seated together properly. If the pins and holes are misaligned sufficiently, proper mounting of the top-tooling may not be possible.

Not all pallet-changing systems rely exclusively on low clearance pinned connections to establish the position of the top-tooling relative to the base. For example, some systems achieve increased accuracy by imparting not just an axial force on the top-tooling, but also a radial force on the pins, causing them to spread apart (or inward), pressing on their respective positional surfaces. This results in increased accuracy as the top-tooling finds elastic equilibrium. However, the repeatability of a system relying on elastic averaging generally improves with increasing number of contact surfaces, and the increasing complexity (especially in terms of moving parts), of such existing systems with increased number of contact surfaces may contribute to the reality that many commonly available systems have a small number of contact points constraining the top tooling laterally. Often times, there are only 4 contact points constraining the top tooling laterally, that is, in X, Y, and C.

A disadvantage of such systems is that the surface area contact at the positional surfaces is small, resulting in high stress and potentially high deflection under load. To combat this, existing systems provide high preload forces in the z direction such that the relatively compliant contact surfaces are not required to constrain movement of the top-tooling when it experiences lateral loading, but instead the frictional force between the top-tooling and base resists lateral movement, such that little or no movement occurs while in use. This can be achieved as long as the preload force is sufficiently high in comparison to other outside forces imparted on the top-tooling, such as that from cutting tools, vibration, or inertial forces due to acceleration. However, these high preload forces necessitate the use of large and/or high strength components which increases cost. The need for high preload force is increased due to the low coefficient of friction between most materials in the presence of oil, cutting fluid, coolant, or other lubricants which are common in manufacturing environments.

Regardless of the method of constraining the 6 degrees of freedom, most existing systems employ a method of applying a preload in the z direction. One problem of existing systems, is that applying such a preload is often associated with additional undesirable preload in one or more lateral directions. This can cause movement of the top-tooling due to translation, rotation, and/or due to elastic deformation. To overcome this problem, existing systems often use complex mechanisms that reduce unwanted sidewise movement. However, the complexity and multiple moving parts that are used to achieve this add to cost of manufacturing and assembling the system.

### BRIEF SUMMARY OF THE INVENTION

This repeatable clamping device allows for the repeatable location of top-tooling to a base in all 6 degrees of freedom. Furthermore, it achieves preloading in the z direction with a low amount of undesirable preload in the lateral degrees of freedom (X translation, Y translation, and C rotation), and achieves that with a small number of mechanical components. In a preferred embodiment of the invention, the device does not rely on small clearances between the mating components to achieve repeat accuracy.

In a preferred embodiment of this invention, location of top tooling relative to a base is achieved, in all 6 degrees of freedom, by use of a Hirth coupling. Hirth couplings or “Hirth joints” are well known to be highly repeatable, and capable of transferring high loads when fixed together using a preloading mechanism. In the case of this invention, the load in the z direction is provided by use of a swiveling pull stud, which engages a ramp in the base, providing a preloading in the z direction such that the surfaces of the serrations in the top-tooling and base come into contact with one another. The pull stud has a spherical surface that makes contact with a retaining cup, installed in the top-tooling, with a corresponding spherical surface such that the pull stud is allowed to rotate about the center of rotation which is approximately located at the center of the spherical surfaces. Meanwhile, the angle of the ramp, and location of a tightening device, which is preferably a set screw, are chosen such that the sum of forces acting on the pull stud by the tightening device and the ramp are in the downward z direction with minimal forces in the X and Y directions. Also, the sum of the moments due to the forces from the set screw and reaction forces at the ramp is small. Because the swiveling pull stud is allowed to swivel within the retaining cup, any moment imparted by the retaining cup on the pull stud (or by the pull stud on the retaining cup) is minimized. Because the reaction force at the ramp, including the normal force and force due to friction, is balanced with the force from the set screw, the pull stud moves slightly downward as the set screw is tightened, causing the retaining cup to deform elastically, along with the serrations in both the top-tooling and base, and along with the pullstud itself. Hence, preloading in the z direction is achieved without substantial loading of the top-tooling in the X or Y directions, and without substantial loading of the top-tooling in any of the rotational degrees of freedom.

A chief advantage of the preferred embodiment of this invention, is that alignment of the top-tooling and base does not have to be strictly coaxial. Preload in the predominantly downward z direction is achieved even when the components are not perfectly aligned. This allows for lower cost manufacture of the components, because machining tolerances do not have to be excessively tight.

In a preferred embodiment of this invention, the ramp is a spherical surface, which is of a radius greater than or equal to the radius on the corresponding surface of the pull stud. With radii that are very close to one another, hertzian contact stresses are minimized, and a sufficiently sized contact patch can exist at the ramp to support the loads needed.

The invention described here improves on the repeatability of location of the top-tooling to the base of the pallet changer. Furthermore, the repeatability of the top tooling does not depend greatly on the precision with which the base was made, because a large number of contact patches are utilized, resulting in a large degree of elastic averaging, leading to precise relocation of the top-tooling in all 6 degrees of freedom.

A preferred embodiment of the invention described here also improves on robustness of positioning in the event of an overload. In a pre-existing system relying on friction between two flat planes, a large transverse force may cause the two planes to slide relative to one another, and then lock in place again in a different position once the force is removed. For example, this could occur if the top-tooling is tapped in the X or Y direction with a hammer, or during a machining operation where the cutting tool is used to take an excessively large cut of workpiece material. In contrast, a preferred embodiment of this invention is positively locking in it's equilibrium position. Furthermore, the geometry of the Hirth coupling is such that in the event of an overload condition that leads to the coupling separating, the two components will return again approximately to their equilibrium position when the excessive load is removed, without locking up prematurely due to friction. This occurs when the included angle of the Hirth serrations are sufficiently small relative to the coefficient of friction between mating surfaces, and when the preload force is sufficiently aligned in the downward z direction.

A preferred embodiment of the invention described here also provides rotary indexing in increments depending on the number of serrations used in the Hirth coupling geometry. For example, if there are 24 serrations, then the indexing increment is 15 degrees. This can be useful to a user because they can use the coupling to access various sides of a workpiece.

In a preferred embodiment of the invention, the included angle of the serrations is approximately 90.1228 degrees, with 24 serrations, such that the serrations can be manufactured using a 3 axis cnc milling machine using a 90 degree chamfer endmill. This is in contrast to commonly available 60 degree and 90 degree included angles, which cannot be finish machined using only a 3 axis milling machine and commonly available chamfer endmill, but instead require at least 1 additional degree of freedom for the cutting tool, or workpiece, or require multiple finish passes using 3d machining techniques. The included angle can also be specified such that other commercially available chamfer endmills can be used to finish machine the serrations, where the calculated included angle of the serrations depends on the included angle of the cutting tool as well as the number of serrations.

The invention described here also reduces the amount of preload required in the z direction compared to devices relying on friction to fix the top-tooling in place. Due to the positive locking nature of the angled serrations, resistance to lateral forces is of the same magnitude as the preload force. This is in contrast to pre-existing systems relying on friction, where the resistance to transverse forces is only a fraction of the preload force, necessitating larger preload forces relative to the transverse forces they are designed to resist.

By using a smaller included serration angle, the resistance to sideways forces can be increased even further.

By using a different number of evenly spaced serrations, other increments of rotation can also be realized. Many combinations of serration angle and number of teeth are possible, and can be manufactured with standard commercial chamfer endmills in standard sizes.

The required Hirth coupling geometry can be approximately determined using known equations to determine the approximate cutting path angle for the chamfer endmill, and then iteratively refined with the aid of computer aided design software until the convex and concave features have an equal included angle resulting in theoretically full and symmetric contact between the base and top-tooling. Note that there will not be contact in some regions where the geometry is relieved for manufacturability. For example, a coupling of 24 serrations, machined with a 90 degree included angle chamfer endmill, would result in 48 mutual contact patches between the top-tooling and base, with an included angle of approximately 90.1228 degrees, and a cutting path angle of approximately 3.75 degrees. Manufacturing can be accomplished on a 3 axis cnc mill such that all serrations are machined using motion in X, Y, and Z. This does not require a rotary axis on the machine. This can be advantageous for users that wish to create their own top-tooling, which can be readily achieved by a competent CNC machinist, when provided with accurate 3D CAD models and instructions for performing the machining operations.

The invention described here also provides an improved mechanism for applying a preload in the z direction, without applying substantial loading in the other 5 degrees of freedom. This is important for minimizing deflection, which would lead to a variation of the position of the top tooling with varying levels of preload. Though other systems exist for applying preload in the z direction, this invention does so with a small number of inexpensive components, while allowing the user to actuate the preload from the periphery of the device, so as not to interfere with the top tooling, or the table on which the device is mounted.

In another embodiment of the invention, instead of serrated Hirth features, either the base or top-tooling utilizes one or more protruding features, corresponding to matching recessed features on the other component. Though the repeatability of the assembly could be limited if there is clearance between the protruding features and the recessed features, the device still has the advantage of applying a preload in the downward z direction with a simple cost-effective mechanism, and without applying excessive undesirable preloads or moments in transverse directions.

Other embodiments utilizing other zero clearance couplings, for example, curvic couplings are also possible, as well as joints utilizing interference fits.

Other embodiments utilizing a tightening device in the form of a non-rotating plunger instead of a rotating set screw are also possible. Such a tightening device could be actuated mechanically, electromechanically, hydraulically, pneumatically, or by other means.

In another embodiment of the invention, the base can have a flat top surface with no locating features other than the flat planar surface. In such a configuration, the base would be used to provide a preload force in the z direction without constraining translation in X, and Y and without constraining rotation about the Z axis, also known as rotation in C. In this way, the user is free to constrain the top-tooling in the remaining 3 degrees of freedom using other means.

In another embodiment of the invention, the swiveling pullstud is stowed in an angled position by use of a spring, magnet, or other means, such that the top-tooling can be lowered directly downward onto the base by an automated means, such as a robotic arm or existing pallet changing system.

In a preferred embodiment of the invention, the swiveling pull stud is free to move so that the user can lower the pull stud into the base, and then translate the top tooling so that the Hirth serrations align, before completely lowering the top-tooling onto the base. In this way, the system is capable of being used in any available angular increment without binding.

### BRIEF DESCRIPTION OF THE DRAWINGS

FIG. 1 shows the base assembly and top tooling.

FIG. 2 shows a front view of the repeatable clamping device.

FIG. 3 shows a right side view of the repeatable clamping device.

FIG. 4 shows a top view of the repeatable clamping device.

FIG. 5 shows a bottom view of the repeatable clamping device.

FIG. 6 shows base assembly as used with a vise top-tooling.

FIG. 7 shows a front view of the repeatable clamping device.

FIG. 8 shows a right side view of the repeatable clamping device.

FIG. 9 shows a bottom view of the repeatable clamping device.

FIG. 10 shows a top view of the repeatable clamping device is shown with vise top-tooling.

FIG. 11 shows an isometric view of the base assembly.

FIG. 12 shows a front view of the base assembly.

FIG. 13 shows a right side view of the base assembly.

FIG. 14 shows a bottom view of the base assembly.

FIG. 15 shows a top view of the base assembly.

FIG. 16 shows an isometric view of the base puck.

FIG. 17 shows a front view of the base puck.

FIG. 18 shows a right side view of the base puck.

FIG. 19 shows a bottom view of the base puck.

FIG. 20 shows a top view of the base puck.

FIG. 21 shows an isometric view of the retaining cup.

FIG. 22 shows a front view of the retaining cup.

FIG. 23 shows a right side view of the retaining cup.

FIG. 24 shows a bottom view of the retaining cup.

FIG. 25 shows a top view of the retaining cup.

FIG. 26 shows an isometric view of the set screw.

FIG. 27 shows front view of the set screw.

FIG. 28 shows a right side view of the set screw.

FIG. 29 shows a bottom view of the set screw.

FIG. 30 shows a top view of the set screw.

FIG. 31 shows an isometric view of the swiveling pullstud.

FIG. 32 shows a front view of the swiveling pullstud.

FIG. 33 shows a right side view of the swiveling pullstud.

FIG. 34 shows a bottom view of the swiveling pullstud.

FIG. 35 shows a top view of the swiveling pullstud.

FIG. 36 shows a cross section view of the repeatable clamping device.

FIG. 37 shows a cross section view of the repeatable clamping device is shown, with the swiveling pullstud swiveled to the side.

FIG. 38 shows a cross section view of a monolithic vise mounted to the base assembly.

FIG. 39 shows cross section view of the base assembly and top tooling.

FIG. 40 shows an isometric view of compatible top-tooling in the form of a dual station monolithic vise.

FIG. 41 a front view of compatible top-tooling in the form of a dual station monolithic vise.

FIG. 42 shows a right side view of compatible top-tooling in the form of a dual station monolithic vise.

FIG. 43 shows a bottom view of compatible top-tooling in the form of a dual station monolithic vise.

FIG. 44 shows a top view of compatible top-tooling in the form of a dual station monolithic vise.

FIG. 45 shows a right angle adapter.

### DETAILED DESCRIPTION AND BEST MODE OF IMPLEMENTATION

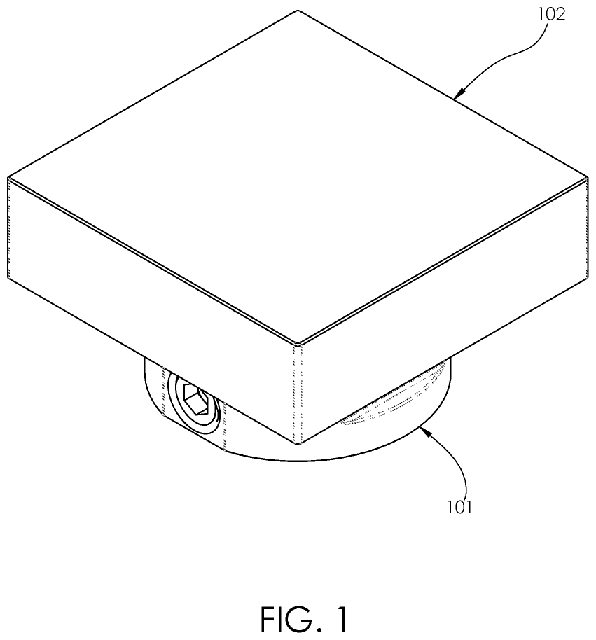

Referring to FIG. 1, the repeatable clamping device is shown. Shown are the base assembly 101, and top-tooling 102.

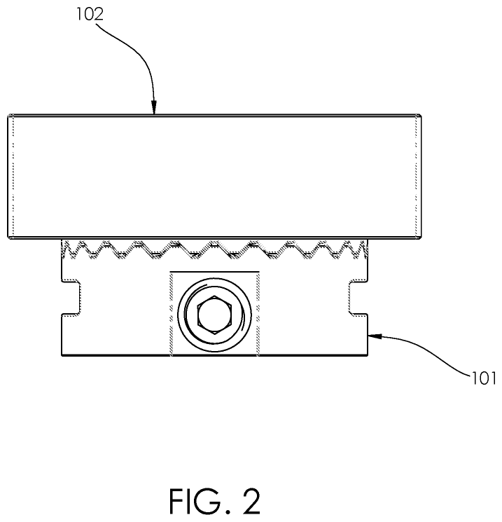

Referring to FIG. 2, a front view of the repeatable clamping device is shown.

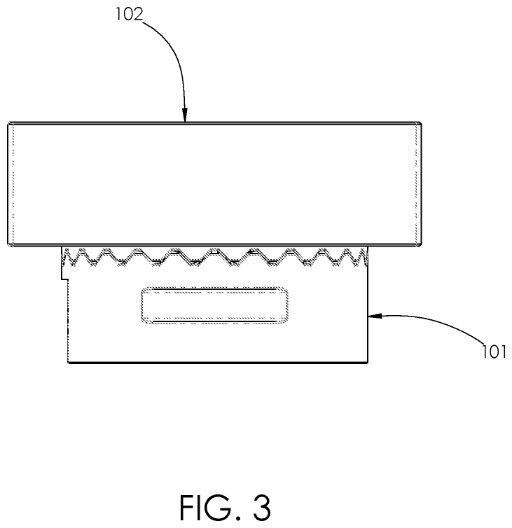

Referring to FIG. 3, a right side view of the repeatable clamping device is shown.

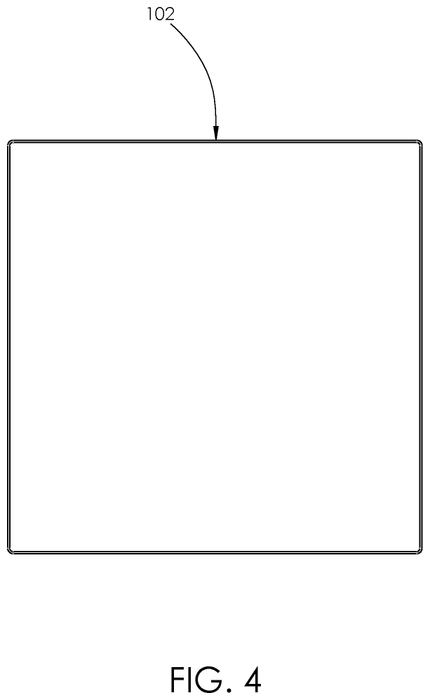

Referring to FIG. 4, a top view of the repeatable clamping device is shown. The top-tooling 102 obscures view of the base assembly 101 in this view.

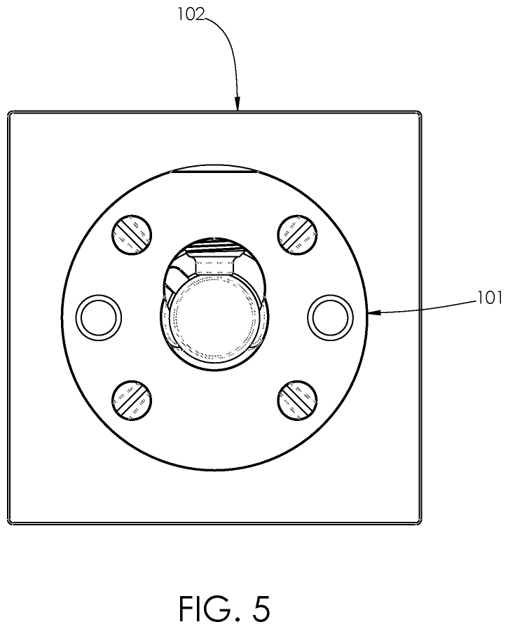

Referring to FIG. 5, a bottom view of the repeatable clamping device is shown.

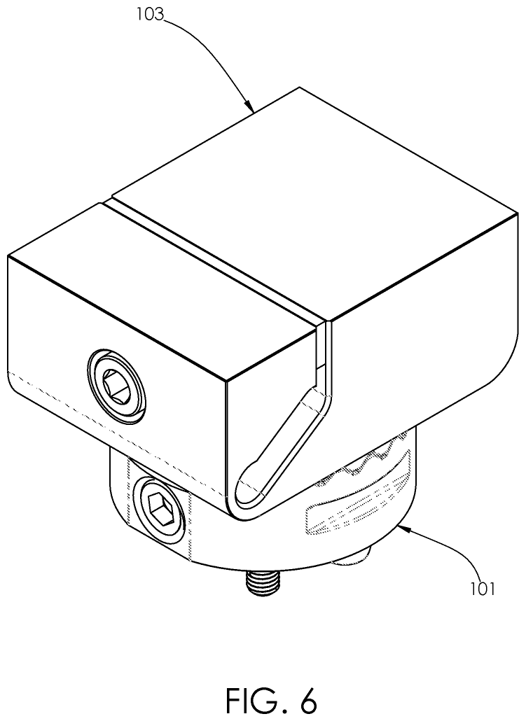

Referring to FIG. 6, shown are the base assembly 101 as used with a vise top-tooling 103.

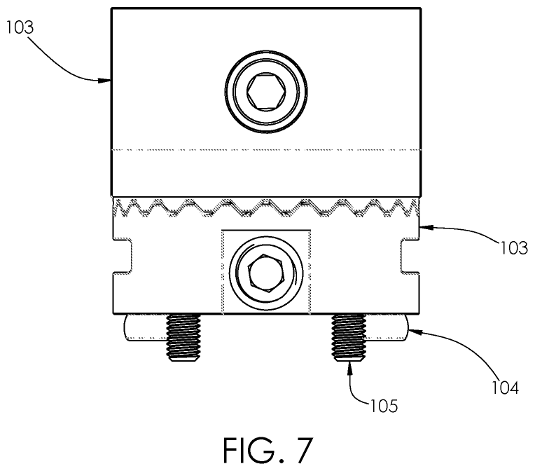

Referring to FIG. 7, a front view of the repeatable clamping device is shown with a vise top-tooling 103. Shown are locating studs 104 and attachment screws 105, for locating and securing the base assembly 101 to the machine table, subplate, or other surface.

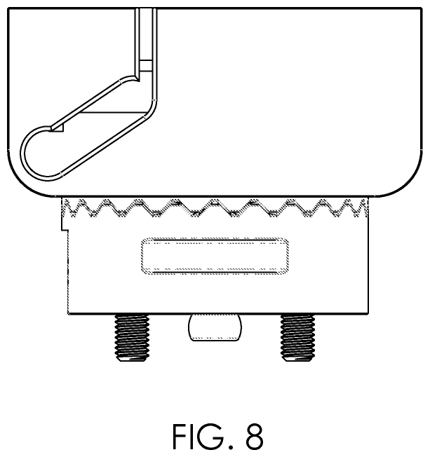

Referring to FIG. 8, a right side view of the repeatable clamping device is shown, utilizing a vise top-tooling.

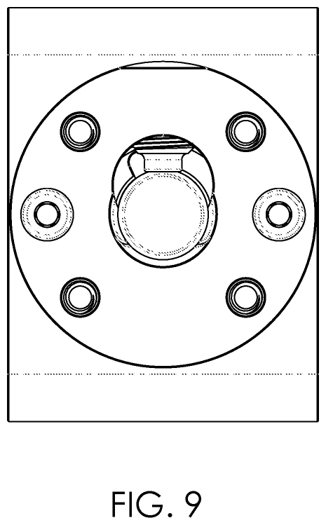

Referring to FIG. 9, a bottom view of the repeatable clamping device is shown, utilizing a vise top-tooling.

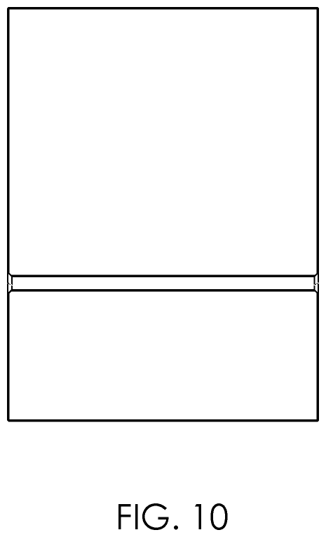

Referring to FIG. 10, a top view of the repeatable clamping device is shown, utilizing a vise top-tooling.

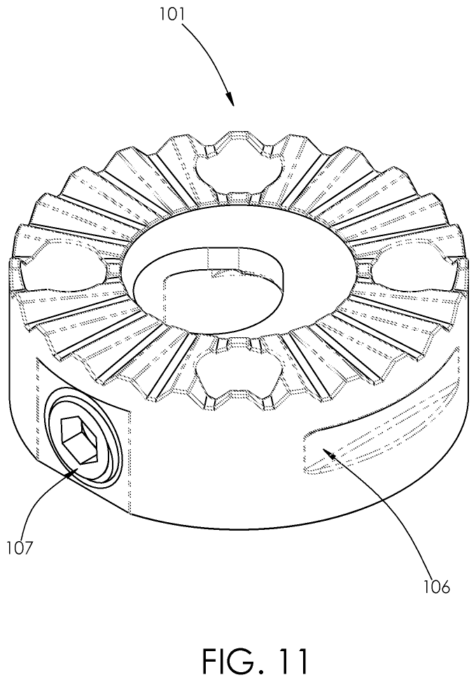

Referring to FIG. 11, an isometric view of the base assembly 101 is shown. A clamping slot 106 is seen on the right side. The set screw 107 is shown, which is actuated by the user from the front of the device.

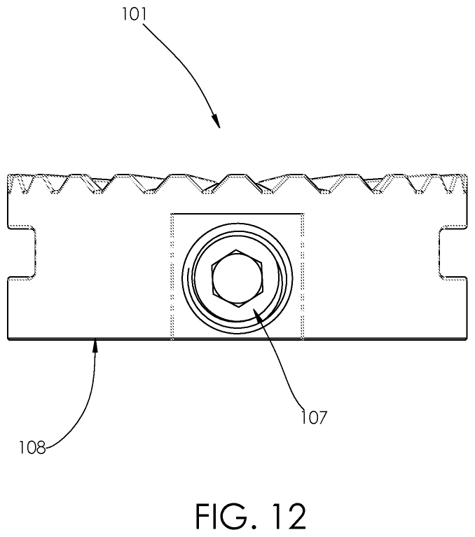

Referring to FIG. 12, a front view of the base assembly 101 is shown. The base assembly consists of the base puck 108 and set screw 107.

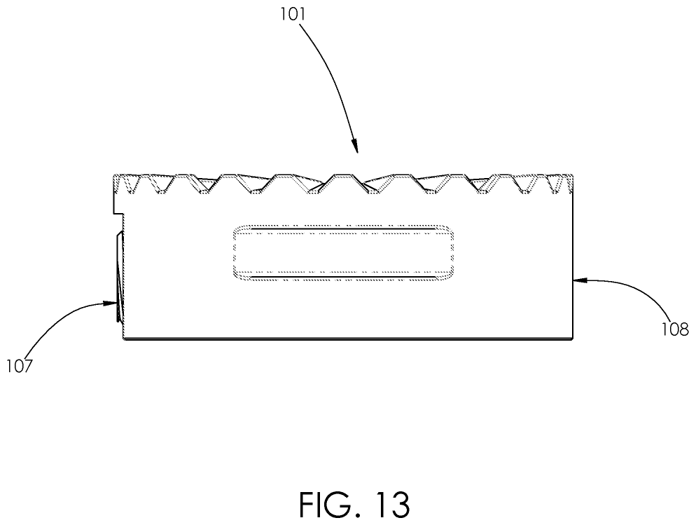

Referring to FIG. 13, a right side view of the base assembly 101 is shown.

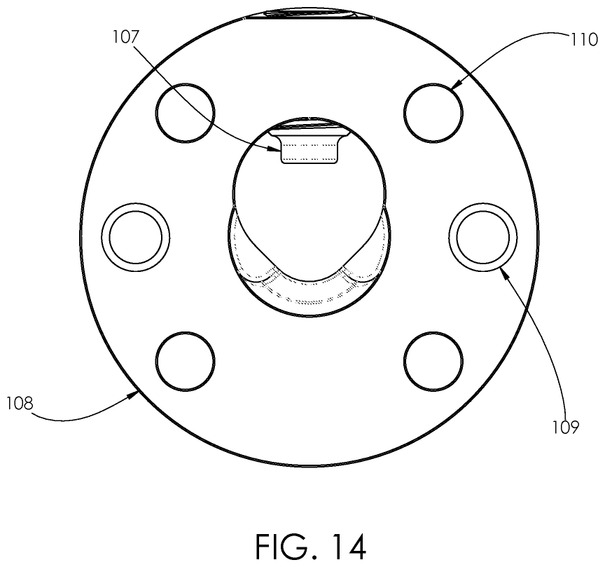

Referring to FIG. 14, a bottom view of the base assembly 101 is shown. Locating holes 109 are visible, in which locating studs 104 may be installed for the purpose of locating the base assembly to a subplate, machine table, or other surface. Also shown are holes 110, through which attachment screws 105 may pass in order to secure the base assembly to a surface.

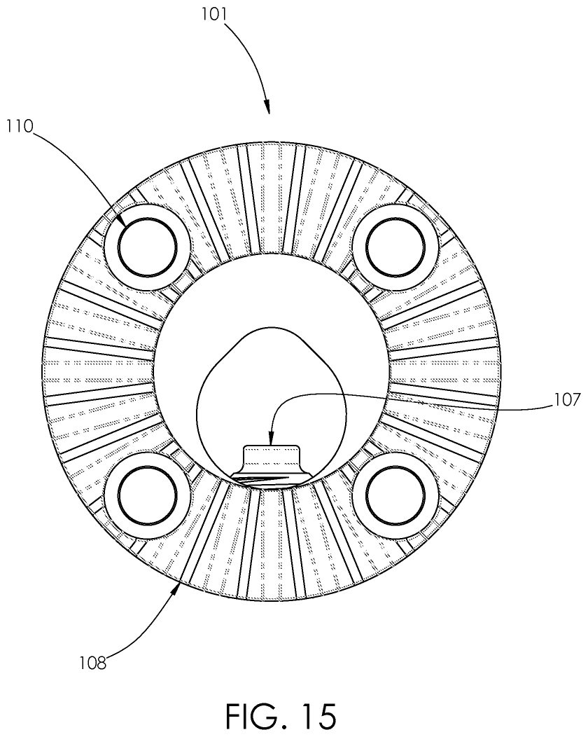

Referring to FIG. 15, a top view of the base assembly 101 is shown.

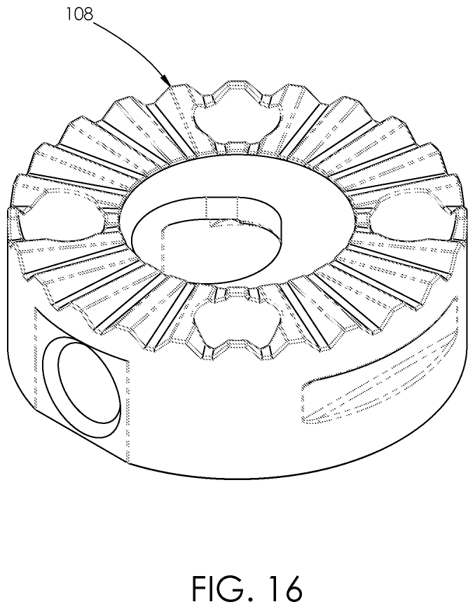

Referring to FIG. 16, an isometric view of the base puck 108 is shown.

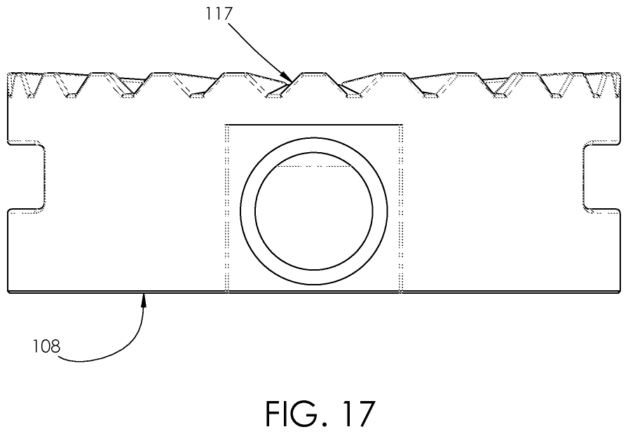

Referring to FIG. 17, a front view of the base puck 108 is shown. Hirth serrations 117 are clearly visible.

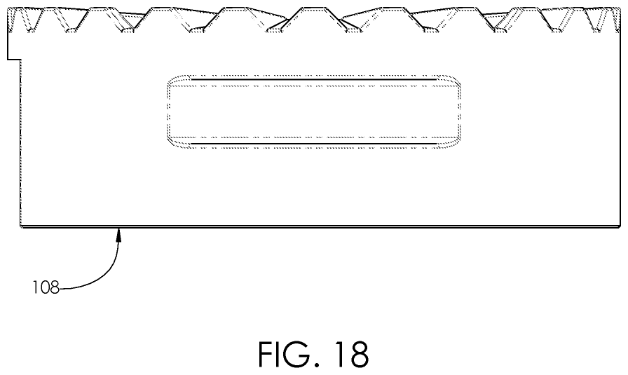

Referring to FIG. 18, a right side view of the base puck 108 is shown.

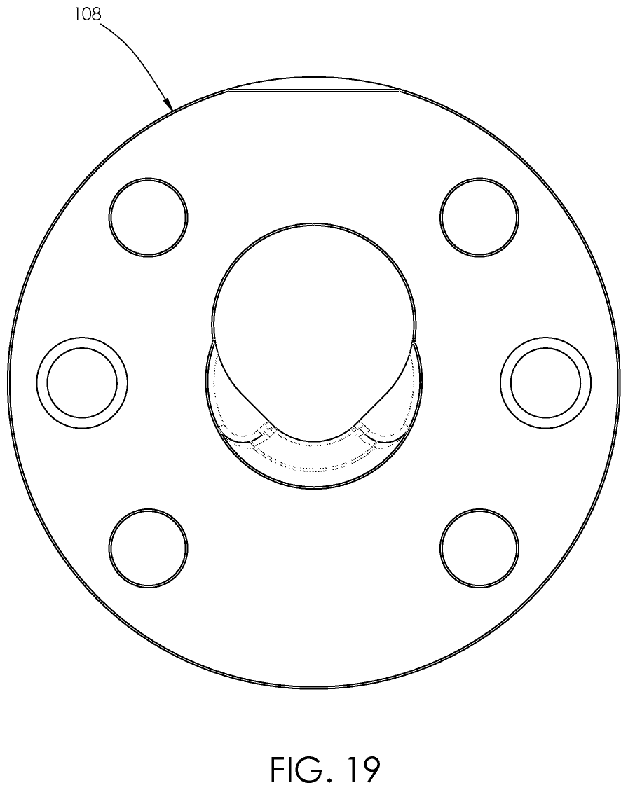

Referring to FIG. 19, a bottom view of the base puck 108 is shown.

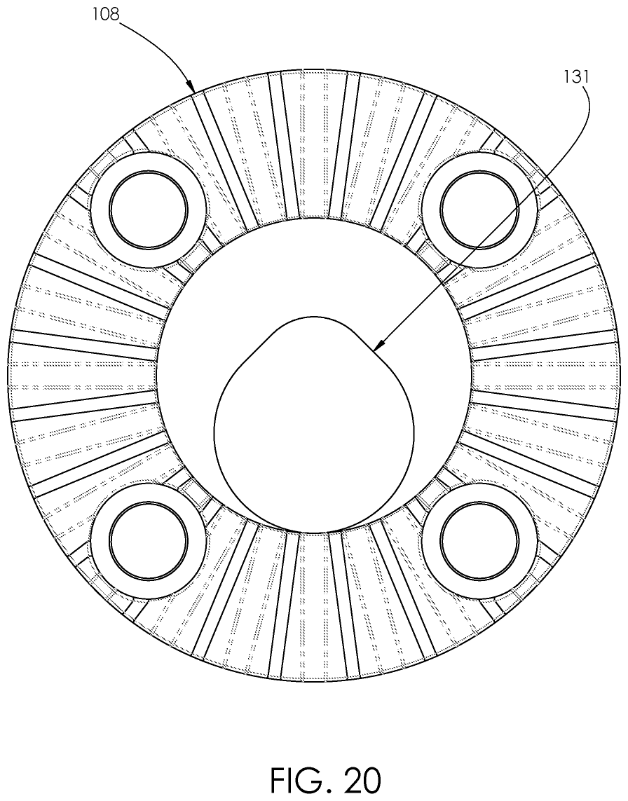

Referring to FIG. 20, a top view of the base puck 108 is shown. Shown is the approximately V-shaped opening 131 in the top which ensures the swiveling pullstud 112 is guided into the necessary position when the device is actuated by the user.

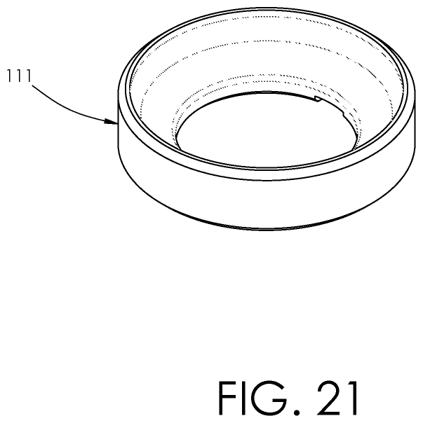

Referring to FIG. 21, an isometric view of the retaining cup 111 is shown. The outer diameter is threaded so that it can be screwed into the top-tooling.

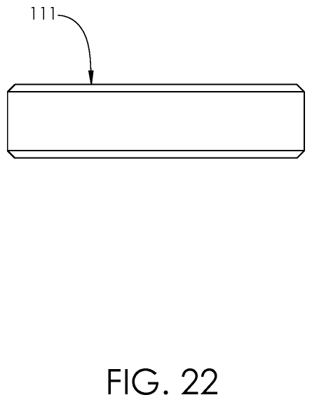

Referring to FIG. 22, a front view of the retaining cup 111 is shown.

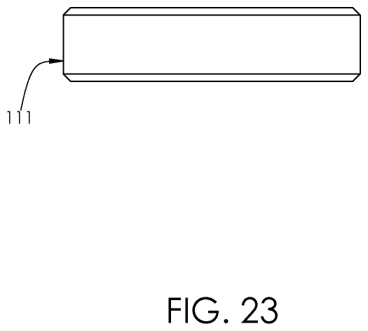

Referring to FIG. 23, a right side view of the retaining cup 111 is shown.

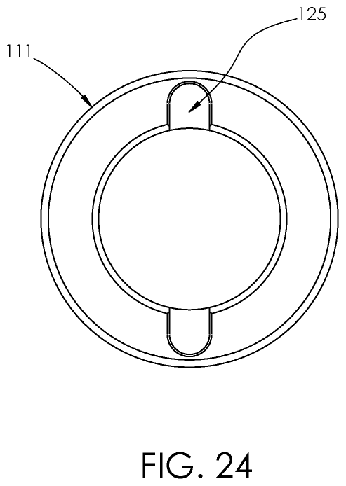

Referring to FIG. 24, a bottom view of the retaining cup 111 is shown. Drive slots 125 are shown, which can be used to tighten the retaining cup into the top-tooling using a spanner wrench or other similar installation tool.

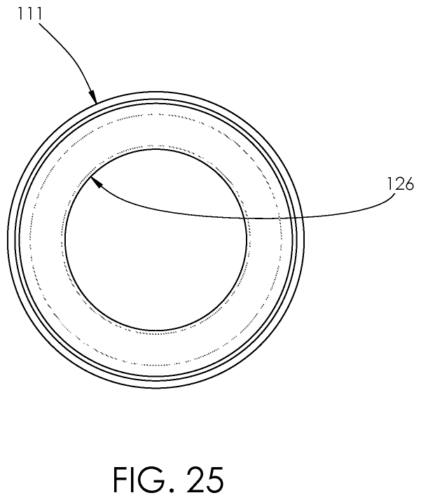

Referring to FIG. 25, a top view of the retaining cup 111 is shown. Clearance hole 126 is sized to be slightly larger than the largest diameter on the swiveling pullstud 112, so that the retaining cup can pass over it and thread into the top-tooling, thereby retaining the swiveling pullstud.

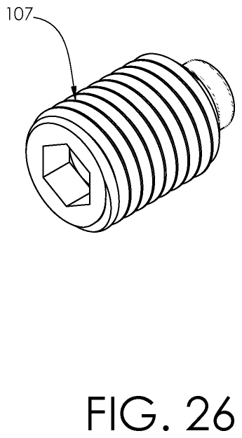

Referring to FIG. 26, an isometric view of the set screw 107 is shown.

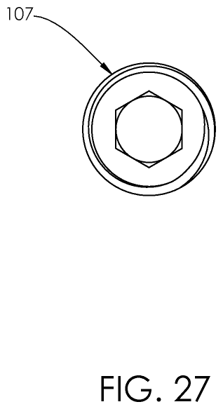

Referring to FIG. 27, a front view of the set screw 107 is shown.

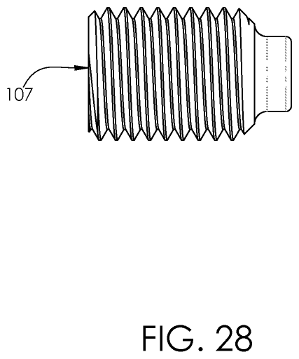

Referring to FIG. 28, a right side view of the set screw 107 is shown.

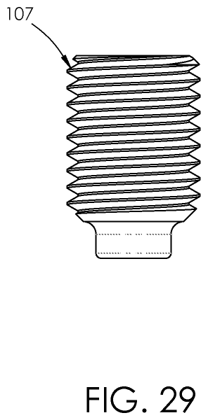

Referring to FIG. 29, a bottom view of the set screw 107 is shown.

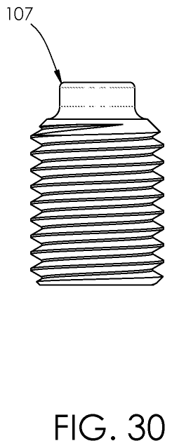

Referring to FIG. 30, a top view of the set screw 107 is shown.

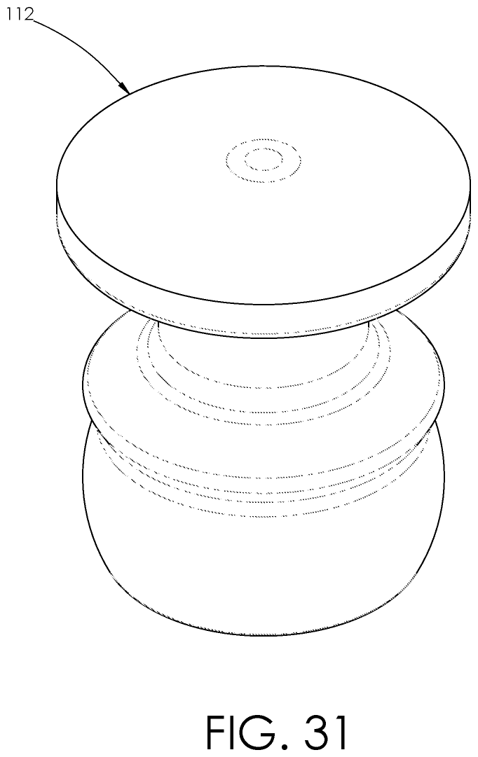

Referring to FIG. 31, an isometric view of the swiveling pullstud 112 is shown.

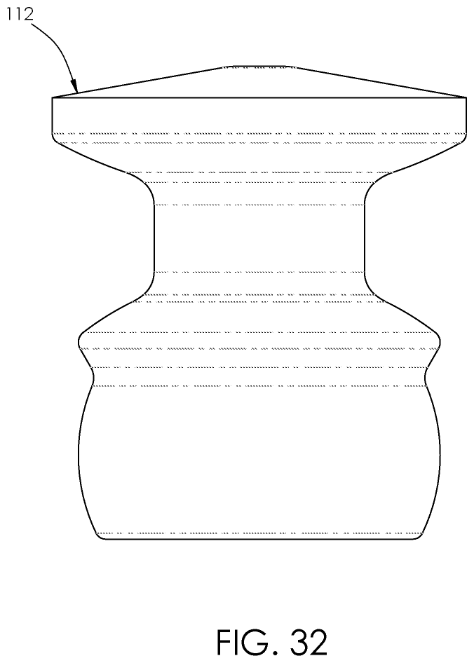

Referring to FIG. 32, a front view of the swiveling pullstud 112 is shown.

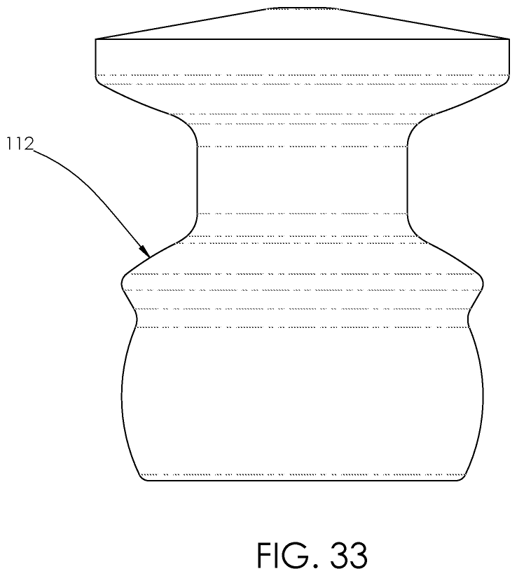

Referring to FIG. 33, a right side view of the swiveling pullstud 112 is shown.

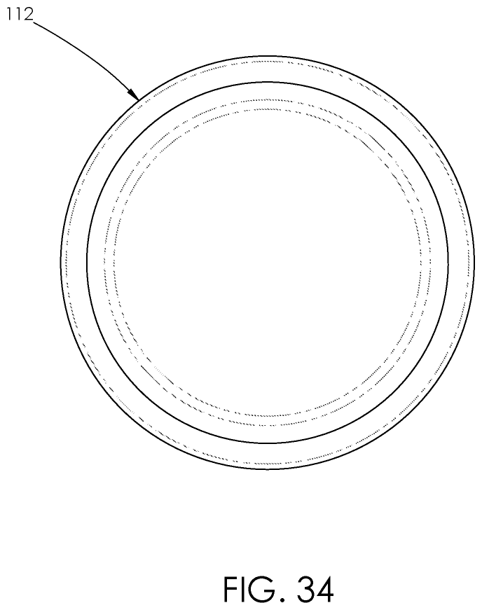

Referring to FIG. 34, a bottom view of the swiveling pullstud 112 is shown.

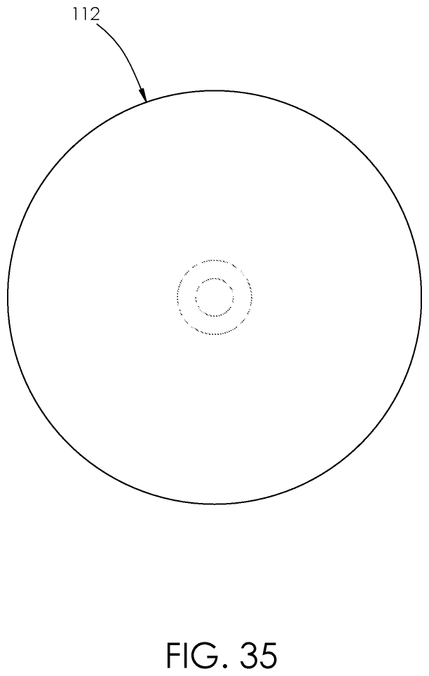

Referring to FIG. 35, a top view of the swiveling pullstud 112 is shown.

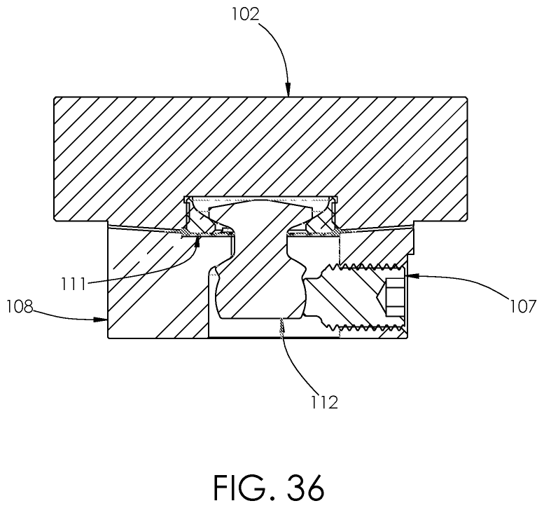

Referring to FIG. 36, a cross section view of the repeatable clamping device is shown.

Shown are top tooling 102, retaining cup 111, swiveling pullstud 112, base puck 108, and set screw 107.

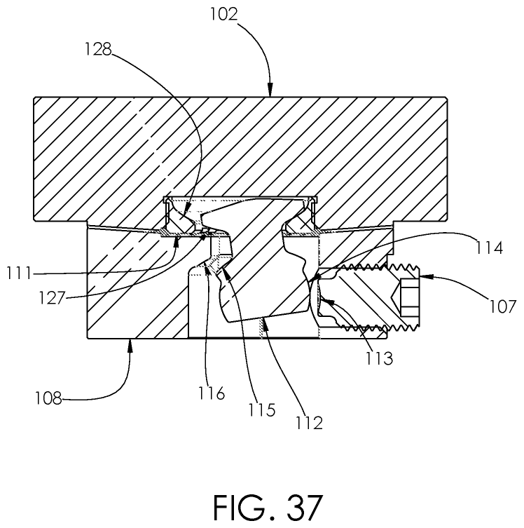

Referring to FIG. 37, a cross section view of the repeatable clamping device is shown, with the swiveling pullstud 112 swiveled to the side as it would be during installation of the top tooling 102 onto the base assembly 101, prior to the top-tooling being secured by the user by actuation of set screw 107. Shown are top tooling 102, retaining cup 111, swiveling pullstud 112, base puck 108, and set screw 107.

Referring to FIG. 37, when the user actuates the set screw 107 by turning it clockwise, the spherical surface 113 comes into contact with the spherical surface 114 of the swiveling pullstud 112, causing the pullstud angled spherical surface 115 to come into contact with the puck angled spherical surface 116. As the set screw 107 is tightened further, elastic deformation occurs in the swiveling pullstud 107, as well as the puck 108, retaining cup 111, and top tooling 102. As the elastic deformation takes place, the pullstud angled spherical surface 115 slides along the puck angled spherical surface 116, resulting in a net force to be experienced by the top-tooling 102 causing the Hirth serrations 118 on the bottom side of the top tooling 102 to come into contact with the Hirth serrations 117 on the top of the base puck 108, locking the two pieces into a secure repeatable position in terms of all 6 degrees of freedom.

Referring FIG. 37, when the user loosens the set screw 107 by turning it counterclockwise, and lifts the top-tooling 102 in the upward z direction, the swiveling pullstud 112 will naturally pivot to the side such that the top-tooling can be removed.

Referring to FIG. 37, the upper spherical pullstud surface 127 slides along the spherical cup bearing surface 128. Both surfaces are approximately equal in radius, and since they are coincident, they have a shared center of rotation.

Referring to FIG. 37, the swiveling pullstud 112 can be stowed in a deflected position by use of a spring or magnet installed into the top-tooling 102, which would cause the swiveling pullstud 112 to not interfere with the base puck 108 when it is lowered directly in the downward z direction by a human, robot, or other automated machinery.

Referring to FIG. 37, to secure the top tooling to the base, the user lowers the top tooling 102 so that the swiveling pullstud 112 passes into the opening in the top of the base puck 108. Then the user translates the top tooling sideways so as to align the Hirth serrations, prior to tightening the set screw 107. In this process, the swiveling pullstud 112 freely pivots so that no binding occurs.

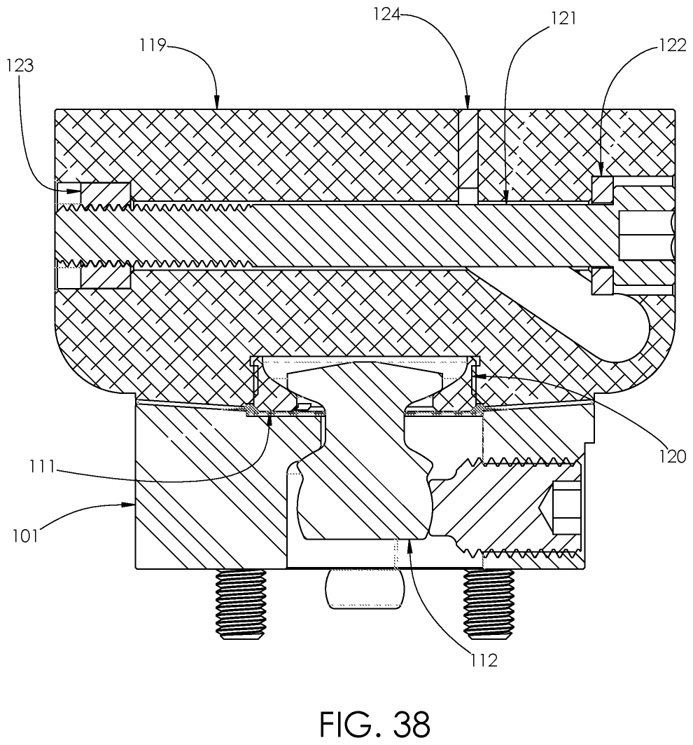

Referring to FIG. 38, a cross section view of a monolithic vise 119 mounted to the base assembly 101 is shown. In this embodiment, the machinable monolithic vise 119 has threaded hole 120, into which the retaining cup 111 threads, thereby retaining the swiveling pullstud 112. The monolithic vise also has the serrated Hirth coupling feature machined into its bottom side. Such a machinable monolithic vise also uses a main screw 121, washer 122, square nut 123, and sacrificial shim 124. After the user machines a cavity into the top of the vise, the sacrificial shim is removed, and the main screw is actuated to clamp on workpieces as needed. In conjunction with the base assembly 101, rapid quick change capabilities are achieved.

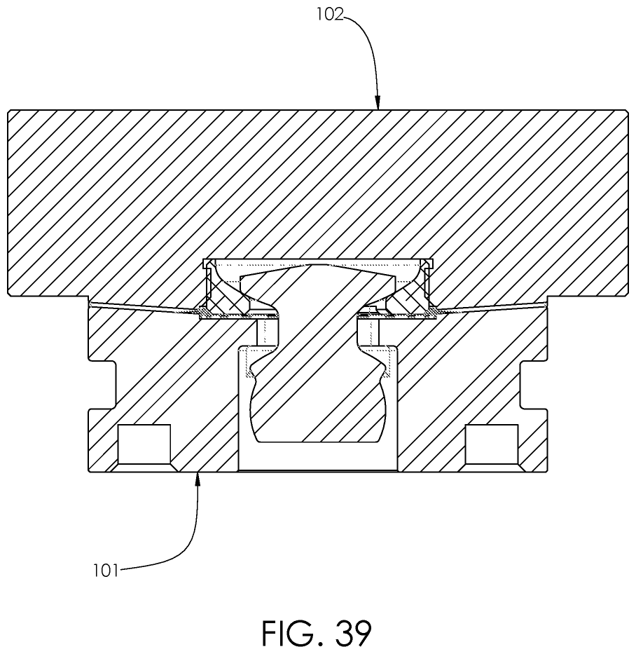

Referring to FIG. 39, a cross section view of the base assembly 101 and top tooling 102 is shown. This plane of the cross section is centered on the base and normal to the y axis.

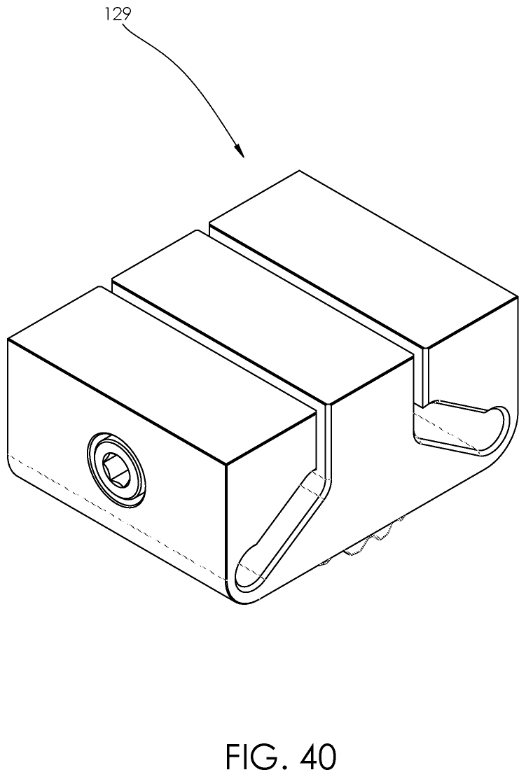

Referring to FIG. 40, an isometric view of compatible top-tooling in the form of a dual station monolithic vise 129 is shown.

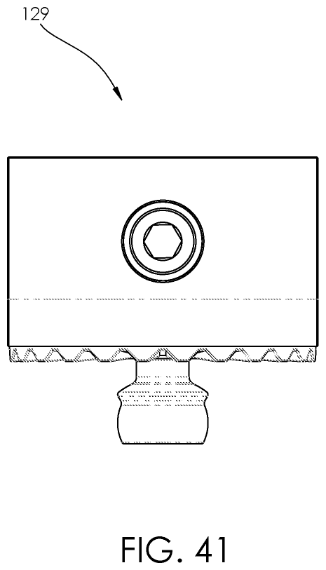

Referring to FIG. 41, a front view of compatible top-tooling in the form of a dual station monolithic vise 129 is shown.

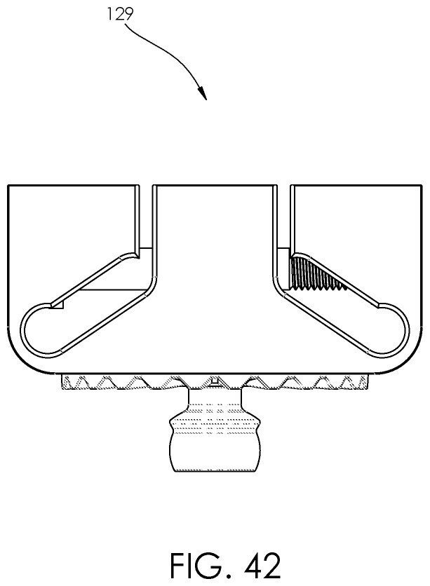

Referring to FIG. 42, a right side view of compatible top-tooling in the form of a dual station monolithic vise 129 is shown.

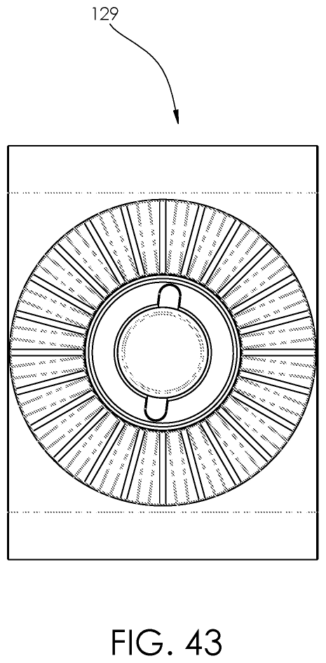

Referring to FIG. 43, a bottom view of compatible top-tooling in the form of a dual station monolithic vise 129 is shown.

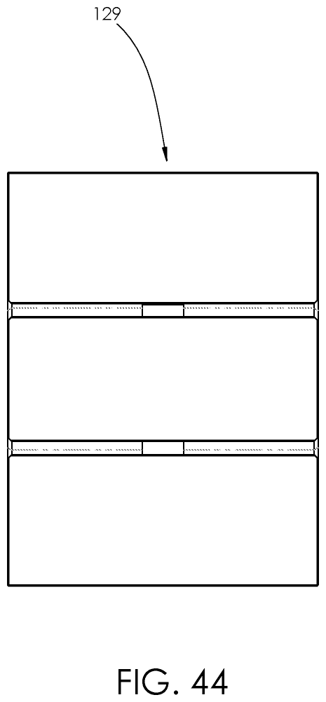

Referring to FIG. 44, a top view of compatible top-tooling in the form of a dual station monolithic vise 129 is shown.

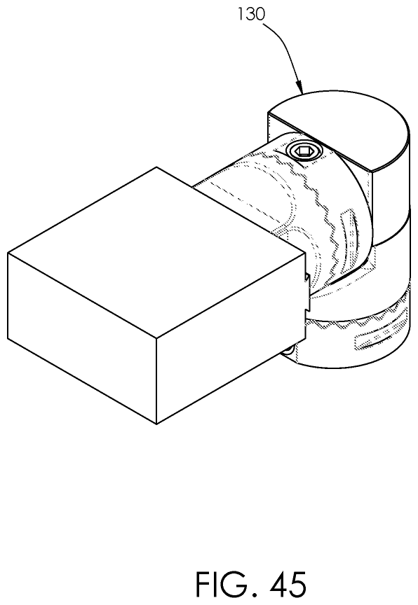

Referring to FIG. 45, a right angle adapter 130 is shown which can be used to enable the user to quickly establish additional axes of rotation, as used to access multiple sides of a workpiece.

1. A clamping device, comprising:
a base comprising a ramp, a tightening device with a spherical contact surface, and a first locating feature; and
top-tooling comprising a second locating feature and a swiveling pullstud;
wherein said swiveling pullstud is equipped with a spherical contact surface facilitating sliding on a corresponding spherical surface integrated into the top-tooling, thereby enabling rotation of the swiveling pullstud, and further featuring an additional spherical surface designed to engage with the corresponding spherical surface of the tightening device in the base;
wherein the tightening device is arranged for applying a force on the swiveling pullstud, and motion of the tightening device effectuates clamping and locating of the top-tooling onto the base by driving an angled surface of the pullstud into contact with the ramp of the top-tooling.

2. The clamping device of claim 1 wherein the first and second locating features are serrated couplings.

3. The clamping device of claim 2 wherein said serrated couplings are Hirth couplings.

4. The clamping device of claim 1 wherein the first locating feature and second locating feature are flat planes, thereby locating the top tooling to the base in only 3 degrees of freedom prior to tightening of the tightening device.

5. The clamping device of claim 1 wherein the first locating feature and second locating feature are one or more holes and their corresponding pins.

6. The clamping device of claim 1 wherein the said ramp is a spherical surface, with a radius that is larger than or equal to the radius of the corresponding angled surface of the pullstud.

7. The clamping device of claim 6 wherein the angled surface of the pullstud is spherical.

8. The clamping device of claim 1 wherein the tightening device is a threaded set screw with a spherical contact surface.
